(19) United States
(12) Patent Application Publication
(10) Pub. No.: US 2018/0229967 A1
(43) Pub. Date: Aug. 16, 2018

(54) ELEVATOR MAINTENANCE ACCESS SYSTEMS FOR ELEVATORS

(71) Applicant: Otis Elevator Company, Farmington, CT (US)

(72) Inventors: Aurelien Fauconnet, Isdes (FR); Frederic Beauchaud, Coullons (FR); Amine Badaoui, Tassigny (FR)

(21) Appl. No.: 15/884,626

(22) Filed: Jan. 31, 2018

(30) Foreign Application Priority Data
Feb. 13, 2017 (EP) 17305159.0

(51) Int. Cl. B66B 5/00; B66B 1/12

(52) U.S. Cl. CPC B66B 5/0087; B66B 1/12

(57) ABSTRACT

Methods and system for operating an elevator include receiving input regarding a maintenance action at an access control module, the input including a first predetermined maintenance position, the first predetermined maintenance position being a position of the elevator car within an elevator shaft relative to a landing, conveying an elevator car to the first predetermined maintenance position, disabling an access prevention device of a landing door lock, and opening a landing door at the landing to enable access to the elevator car positioned at the first predetermined maintenance position.

### CROSS-REFERENCE TO RELATED APPLICATIONS

This application claims the benefit of European Application No. 17305159.0 filed on Feb. 13, 2017, which is incorporated herein by reference in its entirety.

### BACKGROUND

The subject matter disclosed herein generally relates to elevator systems and, more particularly, to access systems and devices for locks and access to elevator cars for elevator maintenance.

Elevator systems include locking mechanisms that are useable by mechanics, technicians, and other authorized persons. The locking mechanisms can be part of lintels or door columns or traps inside the car of the elevator systems and thus may be easily accessible by anyone. However, it may be required by safety regulations and/or advantageous to prevent access to and/or operation of the elevator locking mechanisms at certain times (e.g., when a technician or mechanic is performing a maintenance operation) or when authorized access is not proper. Accordingly, devices that prevent access to the elevator system locking mechanisms may be desirable.

Further, for certain maintenance operations on an elevator car, a mechanic or other person may be required to enter the elevator shaft (e.g., above or below the elevator car). Such position of the mechanic may be dangerous, and thus minimizing access to an elevator shaft and/or enabling maintenance operations to be performed from other locations may be desirable.

### SUMMARY

According to some embodiments, methods of operating an elevator system include receiving input regarding a maintenance action at an access control module, the input including a first predetermined maintenance position, the first predetermined maintenance position being a position of the elevator car within an elevator shaft relative to a landing, conveying an elevator car to the first predetermined maintenance position, disabling an access prevention device of a landing door lock, and opening a landing door at the landing to enable access to the elevator car positioned at the first predetermined maintenance position.

In addition to one or more of the features described above, or as an alternative, further embodiments of the methods may include entering a maintenance mode of operation prior to receiving input regarding the maintenance action.

In addition to one or more of the features described above, or as an alternative, further embodiments of the methods may include that the first predetermined maintenance position is a position of the elevator car relative to the landing that enables access to a first part of the elevator car when the landing door is opened.

In addition to one or more of the features described above, or as an alternative, further embodiments of the methods may include that the first part of the elevator car is an elevator car lintel.

In addition to one or more of the features described above, or as an alternative, further embodiments of the methods may include that the first predetermined maintenance position is a position that defines a first gap between an elevator car lintel top and a landing door top.

In addition to one or more of the features described above, or as an alternative, further embodiments of the methods may include that the first gap is about 300 mm (11.81 inches).

In addition to one or more of the features described above, or as an alternative, further embodiments of the methods may include, wherein the input further includes a second predetermined maintenance position, the second predetermined maintenance position being a position of the elevator car within the elevator shaft relative to the landing that is different from the first predetermined maintenance position.

In addition to one or more of the features described above, or as an alternative, further embodiments of the methods may include the second predetermined maintenance position is a position of the elevator car relative to the landing that enables access to a second part of the elevator car that is different from the first part when the landing door is opened.

In addition to one or more of the features described above, or as an alternative, further embodiments of the methods may include that the second part of the elevator car is an elevator car sill.

In addition to one or more of the features described above, or as an alternative, further embodiments of the methods may include that the second predetermined maintenance position is a position that defines a second gap between an elevator car sill bottom and a landing door bottom.

In addition to one or more of the features described above, or as an alternative, further embodiments of the methods may include that the second gap is about 100 mm (3.94 inches).

In addition to one or more of the features described above, or as an alternative, further embodiments of the methods may include moving the elevator car relative to the first predetermined maintenance position based on input received at the access control module.

In addition to one or more of the features described above, or as an alternative, further embodiments of the methods may include that the movement of the elevator car relative to the first predetermined maintenance position is constrained to a predetermined maximum range.

In addition to one or more of the features described above, or as an alternative, further embodiments of the methods may include closing the landing door and activating the access prevention device of the landing door lock.

In addition to one or more of the features described above, or as an alternative, further embodiments of the methods may include that the landing is a landing within a building that is second from the highest landing within the elevator shaft.

Technical effects of embodiments of the present disclosure include elevator control systems that enable persons to access parts of an elevator car from a landing without having to enter into an elevator shaft. Further technical effects include predetermined maintenance positions that are preset to automatically convey an elevator car to a specific position to allow for maintenance to be performed from a landing of a building. Further technical effects include disabling an access prevention device of a landing door lock only when the elevator car is in a predetermined maintenance position.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of a landing floor of an elevator system with a hall call panel that may employ various embodiments of the present disclosure;

FIG. 3 is a schematic illustration of a lock of an elevator system that can incorporate embodiments of the present disclosure;

FIG. 4 is a schematic illustration of an elevator system in accordance with an embodiment of the present disclosure;

FIG. 5A is a schematic isometric illustration of a landing of a building configured with an elevator maintenance access system in accordance with an embodiment of the present disclosure;

FIG. 5B is a schematic isometric illustration of the elevator maintenance access system of FIG. 5A illustrating calling of an elevator car;

FIG. 5C is a schematic isometric illustration of the elevator car of FIG. 5B shown in a first predetermined maintenance position;

FIG. 5D is a schematic elevation illustration of the elevator car in the first predetermined maintenance position;

FIG. 5E is a schematic isometric illustration of the elevator car of FIG. 5B shown in a second predetermined maintenance position;

FIG. 5F is a schematic elevation illustration of the elevator car in the second predetermined maintenance position; and

FIG. 6 is a flow process for operating an elevator system in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

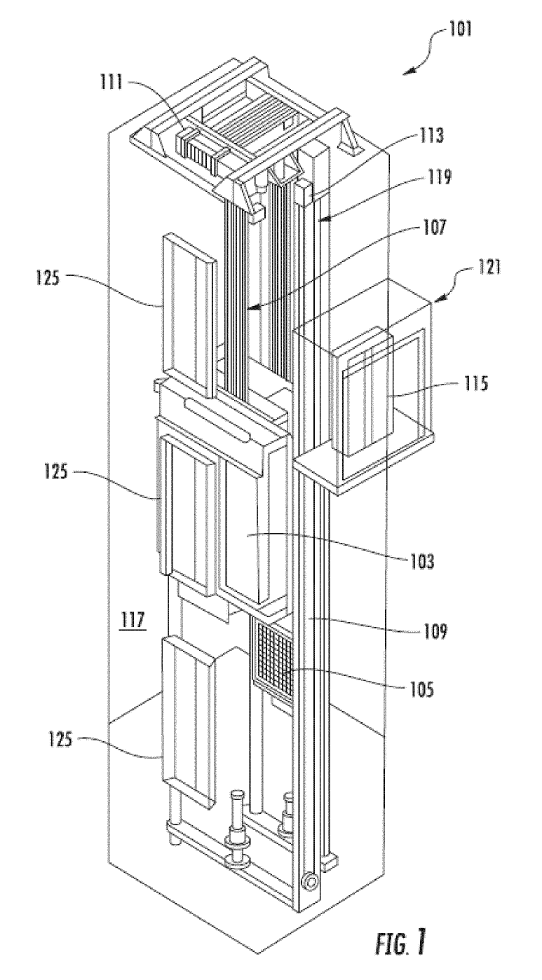

FIG. 1 is a perspective view of an elevator system 101 including an elevator car 103, a counterweight 105, a roping 107, a guide rail 109, a machine 111, a position encoder 113, and an elevator controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown, in a controller room 121 of the elevator shaft 117 and is configured to control the operation of the elevator system 101, and particularly the elevator car 103. For example, the elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

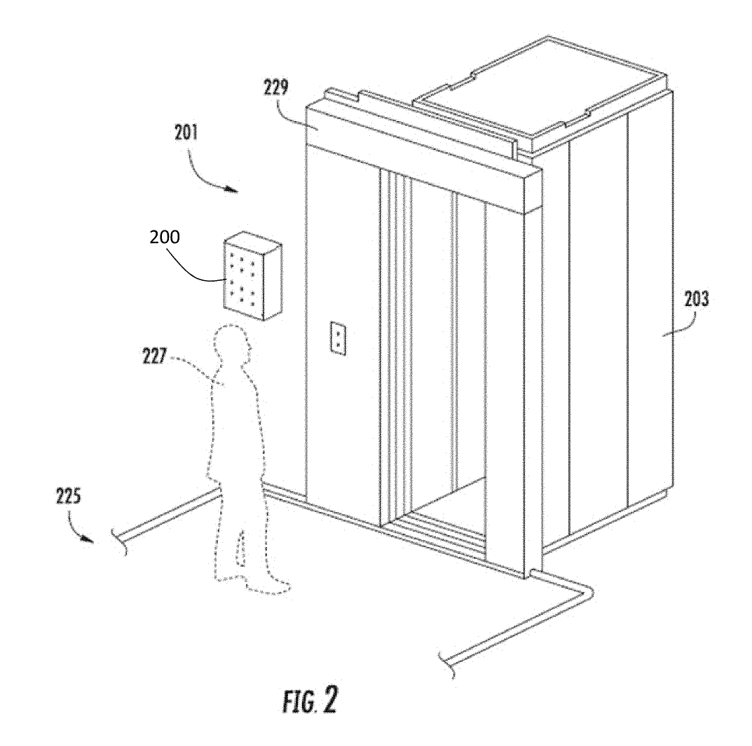

FIG. 2 is a schematic illustration of an elevator system 201 that may incorporate embodiments disclosed herein. As shown in FIG. 2, an elevator car 203 is located at a landing 225. The elevator car 203 may be called to the landing 225 by a passenger or mechanic 227 that desires to travel to another floor within a building or perform maintenance on a portion of the elevator system 201. In some situations, the mechanic 227 may wish to lock a feature of the elevator system, e.g., the elevator doors, an elevator trap, etc., such that the feature(s) cannot be opened or closed (e.g., to prevent unauthorized persons from accessing the elevator system 201 or portions thereof). For example, such situation may arise when the mechanic 227 wishes to access the elevator car and/or shaft to perform maintenance. Such control or locking can be achieved by a lock hole in a landing door lintel 229 of the elevator system 201 (which may be located at one or more landings 225). It may be advantageous to prevent unauthorized persons from accessing the lock and also enable access in a controlled manner. Accordingly, embodiments provided herein are directed to access systems and devices to enable locking/unlocking locks of elevator systems, the systems securely preventing unauthorized access to the locks of the elevator system.

For example, in some configurations, an access control module 200 (e.g., an emergency and test operation module (“ETOM”) or other user control interface) can be located at one or more landings 225 of the elevator system. The access control module 200 can include one or more electrical components that are configured to enable control of an associated elevator system. For example, the access control module 200 can include options for a mechanic or other authorized person to call and/or move elevator cars within an elevator shaft, lock and unlock various locks of the elevator system (e.g., lintel door locks, etc.). The access control module 200 further can enable a mechanic or other authorized person (e.g., emergency personnel) to control and move an elevator car for various reasons.

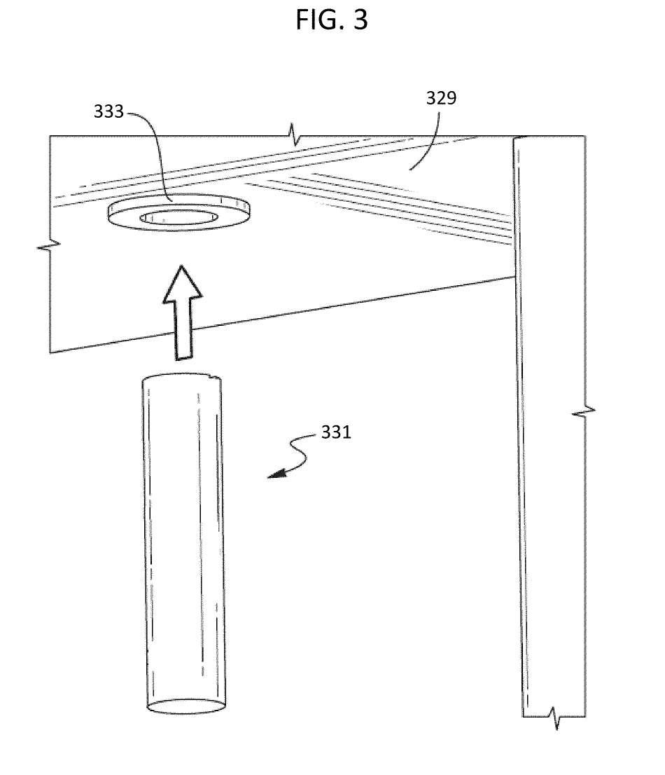

Turning to FIG. 3, a key 331 for use with a lock 333 of an elevator system in accordance with an embodiment of the present disclosure is shown. As shown, the lock 333 is an elevator door lock located within a landing door lintel 329 or landing door column of an elevator doorway. The key 331 is configured to fit within an aperture of the lock 333. Those of skill in the art will appreciate that the locks and keys described herein are not limited to door locks, but rather may be employed in any locks of elevator systems. For example, in other configurations, the lock may be part of a door column or trap inside an elevator car or may be a lock of other parts of elevator systems. Thus, FIG. 3 is merely illustrative and not intended to be limiting. The lock 333 can include access prevention devices or mechanisms configured within the lock 333 to prevent the key 331 from entering the aperture of the lock 333. To enable engagement between the key 331 and the lock 333, a mechanic must take affirmative action (e.g., operating a controller) to disengage or deactivate the access prevention device. Such controller can be incorporated into or be part of an emergency and test operation module (e.g., access control module 200 shown in FIG. 2).

As provided herein, embodiments of the present disclosure may include access prevention devices that can include an obstacle between the lock aperture and a locking device or element that is interacted with a key. For example, an obstacle can be placed to prevent a key from being inserted into and through a lock aperture and thus the key cannot interact with various locking/unlocking elements to operate the lock. In some embodiments, a controller (e.g., computer, processor, etc.) and related software can be configured to pilot and provide authorization to rend locks accessible for mechanics once a specific mode is activated in a control cabinet (e.g., specific elevator control or operation mode).

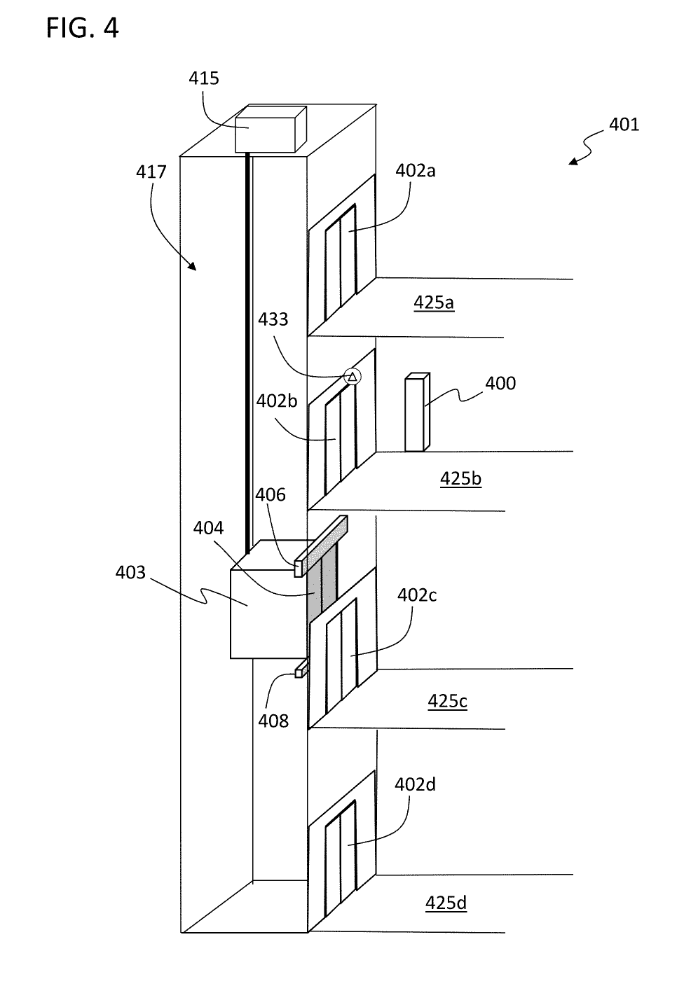

Turning now to FIG. 4, a schematic illustration of an elevator system 401 configured in accordance with a non-limiting embodiment of the present disclosure is shown. The elevator system 401 includes an elevator car 403 movable within an elevator shaft 417 between a plurality of landings 425a, 425b, 425c, 425d. As shown, a first landing 425a is located at the top of the elevator shaft 417, a second landing 425b is located below the first landing 425a, a third landing 425c located below the second landing 425b, and a fourth landing 425d located below the third landing 425c. Although shown with four landings, FIG. 4 is merely provided for illustrative and explanatory purposes and any number of landings can be located along an elevator shaft, as will be appreciated by those of skill in the art.

The first landing 425a includes a respective first landing door 402a, the second landing 425b includes a respective second landing door 402b, the third landing 425c includes a respective third landing door 402c, and the fourth landing 425d includes a respective fourth landing door 402d. The landing doors 402a, 402b, 402c, 402d are configured to be openable only when the elevator car 403 is located at the respective landing door, as will be appreciated by those of skill in the art. However, in certain instances, such as for maintenance and/or in emergencies, access to the elevator shaft 417 through a landing door may be desirable or required. As such, the elevator system 401 is equipped with an access control module 400, similar to that described above. The access control module 400 can be used by a mechanic or other authorized person to control the elevator car 403 within the elevator shaft 417. As will be appreciated by those of skill in the art, the landing doors 402a, 402b, 402c, 402d may be configured to operate through interaction with an elevator car door 404 of the elevator car 403.

At times, maintenance may be required to be performed on one or more parts of the elevator system 401. For example, inspection, repair, replacement, or other maintenance operation may be required to be performed on an elevator car lintel 406 and/or an elevator car sill 408. To access the elevator car lintel 406 or the elevator car sill 408, the maintenance person will need to open one of the landing doors 402a, 402b, 402c, 402d and also move the elevator car 403 to a position that enables access to the elevator car lintel 406 or the elevator car sill 408.

As illustrated in FIG. 4, only the second landing 425b and landing door 402b includes a lock 433 that enables unlocking of the second landing door 402b. The lock 433 of the second landing door 402b can be, in some embodiments, controlled by the access control module 400 that is also located on the second landing 425b. As shown, in the present embodiment, none of the other landings/landing doors 425a/402a, 425c/402c, 425d/402d include a lock. That is, the only landing door that is openable when the elevator car 403 is not present at the respective landing door is the second landing door 402b. Or, stated another way, the first, third, and fourth landing doors 402a, 402c, 402d are permanently locked except when the elevator car 403 is located at the respective landing 425a, 425c, 425d.

The access control module 400 is operably connected to the landing door lock 433 on the second landing 425b. The access control module 400 can enable electrical control over operation and/or access to the landing door lock 433. For example, the access control module 400 can communicate with and/or control an electrical circuit or other mechanism or device to disengage an access prevention device of the lock 433. Additionally, the access control module 400 is operably connected to an elevator controller 415 to enable control of movement of the elevator car 403 within the elevator shaft 417. As such, a mechanic or other authorized person can activate or engage the elevator system into a maintenance mode of operation which can call the elevator car 403 to the appropriate landing/landing door, in this case the second landing 425b and the respective landing door 402b. In some embodiments, the movement of the elevator car 403 upon activation of the maintenance operation can be automated, moving the elevator car 403 to an appropriate predetermined maintenance position, as described herein. Further, in some embodiments, the access control module 400 can be configured to enable adjustment (e.g., manual movement) of the elevator car 403, such as after automatic movement to a predetermined maintenance position.

Thus, to perform maintenance on a portion of the elevator car 402 (e.g., elevator car lintel 406, elevator car sill 408, etc.), the mechanic or other personnel can use the access control module 400 to call the elevator car 403 to the landing that has the access control module 400 (e.g., second landing 425b). As noted, such operation and movement of the elevator care 403 within the elevator shaft 417 can be automated and/or predetermined. To access the elevator car lintel 406 and/or the elevator car sill 408, the mechanic will open the landing door 402b. However, because the maintenance will be performed on the elevator car lintel 406 or the elevator car sill 408, the elevator car 403 will not be aligned with the landing door 402b, and thus the automatic or standard opening of the landing door 402b with operation of the elevator car door 404 will not be possible.

As such, the mechanic will use the access control module 400 to enable access to and operation of the lock 433. After using the access control module 400 to enable access to the lock 433, the mechanic can open the landing door 402b even when the elevator car door 404 is not aligned with the landing door 402b. In some embodiments, when the mechanic activates or engages a maintenance operation, the elevator car 403 will move first, and when the elevator car 403 is positioned relative to the appropriate landing (e.g., second landing 425b), an access prevention device will be operated to enable access to the lock 433. Accordingly, in such embodiments, the second landing door 402b will not be able to be opened unless the elevator car 403 is present at the second landing 425b, even though the elevator car 403 is not aligned with the second landing door 402b as in normal operation.

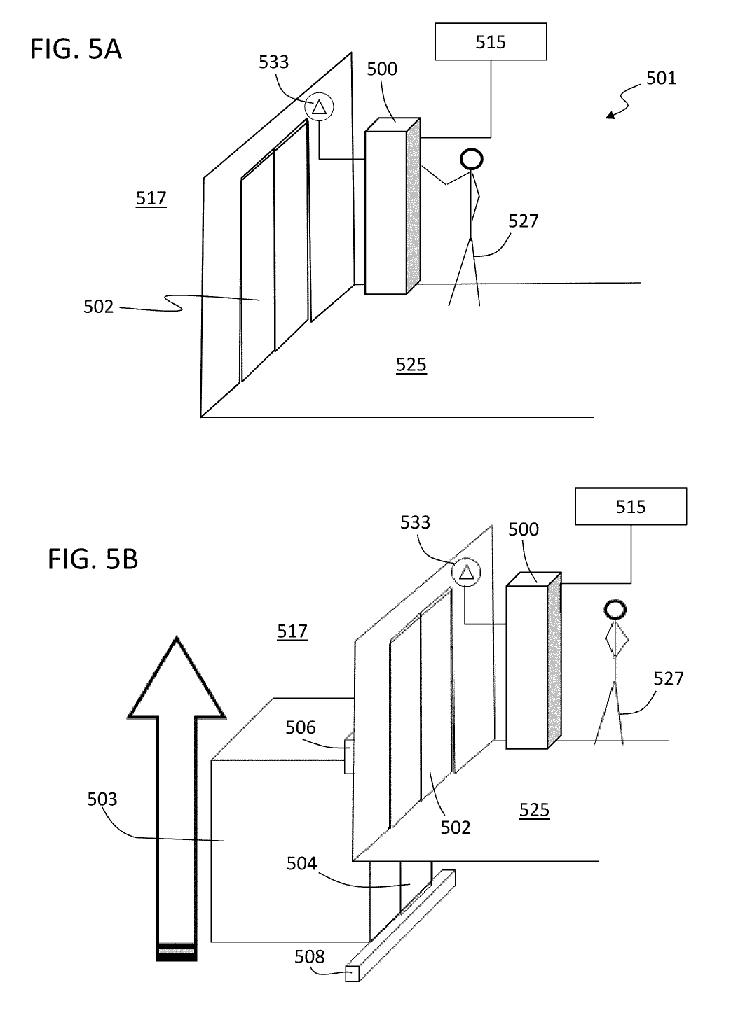

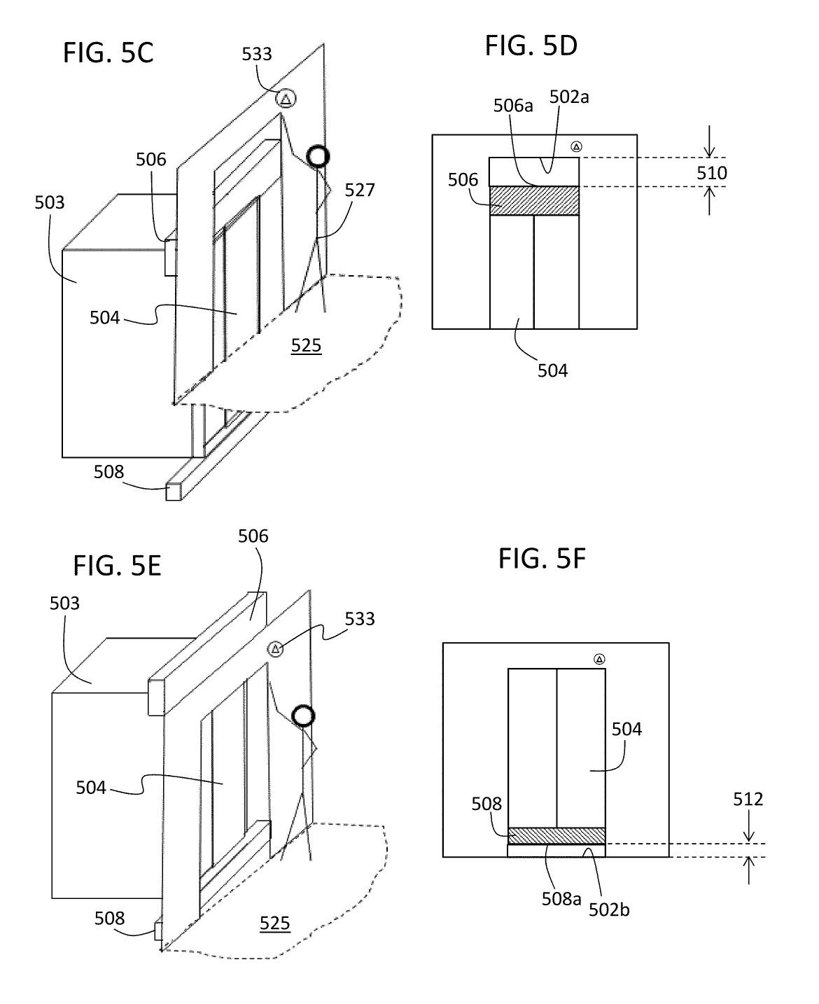

For example, turning to FIGS. 5A-5F, schematic illustrations of operation of an elevator system 501 configured with an elevator maintenance access system in accordance with a non-limiting embodiment of the present disclosure are shown. The elevator maintenance access system of FIGS. 5A-5F may be similar to the systems as described above. As shown, the elevator maintenance access system includes an access control module 500 that is operably connected to a landing door lock 533 and an elevator controller 515 that controls movement of an elevator car 503 within an elevator shaft 517. Similar to the embodiment shown in FIG. 4, as shown in FIGS. 5A-5B, the access control module 500 is located on a landing 525 that includes a landing door 502 having a door lock 533. In some embodiments, all other landings within the same building as landing 525 will not include a door lock, and thus landing door 502 is the only landing door that is openable when an elevator car is not aligned with the land door.

FIG. 5A illustrates a first step of performing an operation using an elevator maintenance access system in accordance with the present disclosure. As shown, a mechanic 527 will interact with the access control module 500 to engage or activate a maintenance mode of operation of the elevator system. When such mode of operation is activated, the access control module 500 communicates with the elevator controller 515 to call the elevator car 503 to the landing 525. In some embodiments, the mechanic 527 can input a specific maintenance operation into the access control module 500. For example, the mechanic 527 can indicate a maintenance operation to be performed on an elevator car lintel 506 or an elevator car sill 508.

In accordance with some embodiments of the present disclosure, each selectable maintenance operation is configured with a predetermined maintenance position to stop the elevator car 503 relative to the landing 525. For example, the access control module 500 can be used to stop the elevator car 503 at a first predetermined maintenance position relative to the landing 525 that enables the mechanic 527 to access the elevator car lintel 506 when the landing door 502 is opened. Similarly, the access control module 500 can be used to stop the elevator car 503 at a second predetermined maintenance position relative to the landing 525 that enables the mechanic 527 to access the car sill 508 when the landing door 502 is opened. As such, the mechanic 527 will be able to perform maintenance on the desired part of the elevator car 503 from the landing 525 and may not need to enter or access the elevator shaft 517.

As shown in FIG. 5B, after the mechanic 527 uses the access control module 500 to activate a maintenance mode of operation, the elevator car 503 is automatically conveyed to the appropriate landing of the building (e.g., landing 525). The elevator controller 515 can move the elevator car 503 to a first predetermined maintenance position or a second predetermined maintenance position, based on a request or information received from the access control module 500 based on input from the mechanic 527 (e.g., as shown in FIGS. 5C-5F and described below).

For example, turning to FIGS. 5C-5D, schematic illustrations of the elevator maintenance access system providing access to the elevator car lintel 506 are shown. FIG. 5C is an isometric illustration showing the elevator car 503 positioned at a first predetermined maintenance position to provide access for the mechanic 527 to perform maintenance on the elevator car lintel 506. As schematically shown, the mechanic 527 is able to operate the lock 533 to open the landing door 502 even though the elevator car doors 504 are not aligned with the landing door 502. In the illustrations of FIGS. 5C-5D, the landing door 502 is not shown because the landing door 502 has been opened by the mechanic 527 after an unlocking operation using the lock 533.

As noted, the first predetermined maintenance position shown in FIGS. 5C-5D is predetermined as part of the maintenance mode of operation and selection by the mechanic 527 at the access control module 500. As shown in FIG. 5D, in the first predetermined maintenance position, the elevator car 503 is stopped at the landing 525 such that a first gap 510 exists between a car lintel top 506a and the bottom of the landing door lintel 502a. The landing door lintel 502a is a top of the opening of the landing door 502 and may be defined by a landing door lintel (e.g., landing door lintel 229, 329 shown and described above). In some embodiments, the lock 533 can be part of or within the landing door lintel, as shown and described above. The first gap 510 is a separation or opening between the landing door lintel 502a of the opening of the landing door 502 (e.g., a frame thereof) and a top of the elevator car 503 (e.g., top 506a of elevator car lintel 506). With the elevator car 503 at the first predetermined maintenance position, the mechanic 527 can easily and safely access the elevator car lintel 506.

In some embodiments the first gap 510 can be predetermined to be sufficiently large to enable access to the elevator car lintel 506 for maintenance operations, but also small enough to prevent or discourage persons from entering the elevator shaft 517 (e.g., on top of the elevator car 503). For example, in one non-limiting embodiment, the first gap is about 300 mm (11.81 inches). In some embodiments, the mechanic 527 can use the access control module 500 to manually adjust the position of the elevator car 503 relative to the landing 525. For example, the access control module 500 can be configured to enable adjustment of the elevator car position within a predetermined maximum range. That is, the elevator car 503 can be moved to a first predetermined maintenance position and then manual operation can be used to adjust the position of the elevator car 503 relative to the first predetermined maintenance position.

Turning to FIGS. 5E-5F, schematic illustrations of the elevator maintenance access system providing access to the elevator car sill 508 are shown. FIG. 5E is an isometric illustration showing the elevator car 503 positioned at a second predetermined maintenance position to provide access for the mechanic 527 to perform maintenance on the elevator car sill 508. As schematically shown, the mechanic 527 is able to operate the lock 533 to open the landing door 502 even though the elevator car doors 504 are not aligned with the landing door 502. In the illustrations of FIGS. 5E-5F, the landing door 502 is not shown because the landing door 502 has been opened by the mechanic 527 after an unlocking operation using the lock 533.

As noted, the second predetermined maintenance position shown in FIGS. 5E-5F is predetermined as part of the maintenance mode of operation and selection by the mechanic 527 at the access control module 500. As shown in FIG. 5F, in the second predetermined maintenance position, the elevator car 503 is stopped at the landing 525 such that a second gap 512 exists between a car sill bottom 508a and a landing door sill 502b. The landing door sill 502b is a bottom of the opening of the landing door 502 and may be defined by a floor of the landing 525. The second gap 512 is a separation or opening between the sill 502b of the opening of the landing door 502 (e.g., floor or sill of landing 525) and a bottom of the elevator car 503 (e.g., bottom 508a of elevator car sill 508). With the elevator car 503 at the second predetermined maintenance position, the mechanic 527 can easily and safely access the elevator car sill 508.

Similar to that described above, in some embodiments the second gap 512 can be predetermined to be sufficiently large to enable access to the elevator car sill 508 for maintenance operations, but also small enough to prevent or discourage persons from entering the elevator shaft 517 (e.g., below the elevator car 503). For example, in one non-limiting embodiment, the second gap can be about 100 mm (3.94 inches). Further, in some embodiments, the mechanic 527 can use the access control module 500 to manually adjust the position of the elevator car 503 relative to the landing 525. For example, the access control module 500 can be configured to enable adjustment of the elevator car position within a predetermined maximum range. That is, the elevator car 503 can be moved to a second predetermined maintenance position and then manual operation can be used to adjust the position of the elevator car 503 relative to the second predetermined maintenance position.

As described above, manual adjustment may be employed in some embodiments of the present disclosure. The manual adjustment from a predetermined maintenance position of the elevator car may be limited, such as within a preset range either up, down, or both up and down, relative to the predetermined maintenance position. For example, in one non-limiting example, the preset range may be based on a percentage of the gap size (e.g., 15% of the gap increase or decrease in position relative to the predetermined maintenance position). In other embodiments, the manual adjustability may be a preset, fixed value (e.g., 50 mm (1.97 inches)). Such manual adjustment may enable the mechanic 527 to access certain parts of the elevator car and/or adjust the position such that the mechanic 527 may more comfortably or easily perform maintenance actions (e.g., inspections, repair, replacement, etc.).

Although described with respect to separate operations in FIGS. 5C-5D (elevator car lintel access) and FIGS. 5E-5F (elevator car sill access), in some embodiments, access to both the elevator car lintel and the elevator car sill can be achieved in a single maintenance operation. In such embodiments, the mechanic can request the elevator car to stop at one of the first or second predetermined maintenance position, using the access control module, to enable an appropriate maintenance procedure. Then, when complete, the mechanic can use the access control module to adjust from the first to the second predetermined maintenance position, or the second to the first predetermined maintenance position.

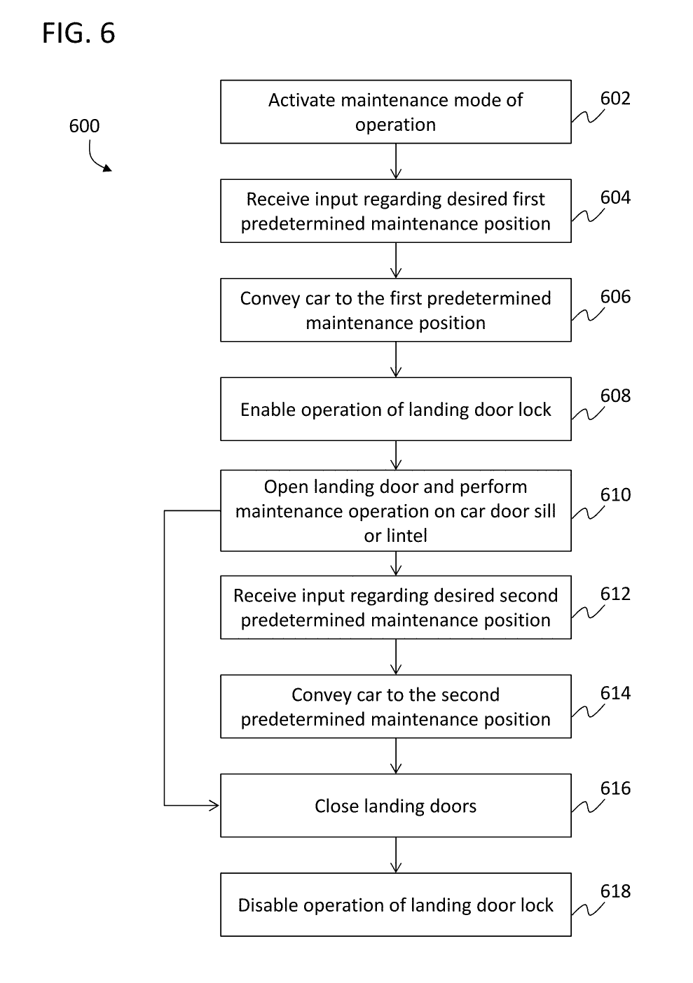

Turning now to FIG. 6, a flow process 600 for controlling an elevator system in accordance with a non-limiting embodiment of the present disclosure is shown. The flow process 600 can be employed in elevator systems similar to that shown and described above, although various other arrangements and/or configurations of elevator systems can employ embodiments of the flow process 600.

At block 602, a maintenance mode of operation is activated. For example, a mechanic or other authorized person can activate the maintenance mode of operation at an access control module located on one of a plurality of floors or landings within a building. As noted above, in some embodiments, the access control module may be provided at a single, designated landing within the building, such as the second from highest landing within the building. The activation of the maintenance mode of operation can enable a mechanic or other authorized personnel to perform maintenance operations on an elevator car within an elevator shaft of the elevator system.

At block 604, with the maintenance mode of operation activated (block 602), the mechanic can make a selection of a desired maintenance operation. As such, the system will receive input (e.g., at the access control module) regarding a selected maintenance operation. The input can include a first predetermined maintenance position that is predetermined to enable the mechanic to access a portion of an elevator car with respect to the first predetermined maintenance position. In some embodiments, the first predetermined maintenance position can be one of the positions shown in FIGS. 5C-5F. The input can be communicated to an elevator controller and/or machine of the elevator system.

At block 606, the elevator car is conveyed to the first predetermined maintenance position. The elevator controller and/or elevator machine drive the elevator car to the first predetermined maintenance position. The first predetermined maintenance position is a specific location within the elevator shaft that is set relative to a landing, e.g., the landing with the access control module. The first predetermined position is a position of a part of the elevator car relative to a doorway of a landing door. When the elevator car is located at the first predetermined maintenance position, if the landing doors are opened, a portion of the elevator car is positioned to be accessible to a person, such as a mechanic or other authorized person.

At block 608, once the elevator car is positioned at the first predetermined maintenance position, a landing door lock is enabled for operation. For example, an access prevention device can be disabled to thus allow for a user of the system to insert a key into a lock and unlock the landing doors. In such embodiment, the access prevention device may be engaged at all times and thus prevent unauthorized access to the landing door lock. The disabling of the access prevention device is associated with the maintenance mode of operation and the elevator car being positioned at a predetermined maintenance position (e.g., the first predetermined maintenance position).

At block 610, with the landing door lock unlocked, the landing doors will open, thus exposing the elevator car that is positioned at the first predetermined maintenance position. With the landing doors open, the mechanic or other personnel can perform a maintenance operation, such as inspection, repair, replacement, etc. of a portion of the elevator car that is accessible at the first predetermined maintenance position. For example, the first predetermined maintenance position can be a position of the elevator car within the elevator shaft and relative to the landing door that enables access to an elevator car lintel (e.g., as shown in FIGS. 5C-5D). In other embodiments, the first predetermined maintenance position can be a position of the elevator car within the elevator shaft and relative to the landing door that enables access to an elevator car sill (e.g., as shown in FIGS. 5E-5F). The first predetermined maintenance position can be any predetermined position, and may be set to enable maintenance operation while also preventing access to the elevator shaft. Thus, the first predetermined maintenance position may be a position that allows a mechanic to perform a maintenance operation on the elevator car from the landing, and does not require the mechanic to enter the elevator shaft.

In some embodiments, after the mechanic performs a maintenance action on the elevator car at the first predetermined maintenance position (e.g., on the elevator car sill), the mechanic can input a second predetermined maintenance position, as shown at block 612. Such request will be sent to the elevator controller and/or machine. The second predetermined maintenance position is a position of the elevator car within the elevator shaft relative to the landing that enables access to a second or different part of the elevator car (e.g., the other of the elevator car sill or elevator car lintel).

The elevator car will then be moved to the second predetermined maintenance position, as shown at block 614. The movement of the elevator car from the first predetermined maintenance position to the second predetermined maintenance position can occur with the landing door open (while in the maintenance mode of operation). In some embodiments, the landing doors can close during the movement of the elevator car from the first predetermined maintenance position to the second predetermined maintenance position. If the landing doors were closed during the movement of the elevator car, once the elevator car reaches the second predetermined maintenance position, the landing doors will open. The mechanic can then perform a maintenance operation with the elevator car in the second predetermined maintenance position and thus access a second part of the elevator car (e.g., the other of the elevator car lintel or elevator car sill).

Once the elevator maintenance is complete, the landing doors are closed, as shown at block 616. The closing of the landing doors may be prompted by the mechanic changing the operation mode of the elevator system from the maintenance mode of operation back to normal operation.

With the landing door closed, the landing door lock access prevention device can be reactivated or operation of the landing door lock can be disabled, as shown at block 618. Thus, after a maintenance action is performed, the landing door lock can be deactivated or otherwise prevented from being used. In some embodiments, in accordance with the present invention, the access prevention device can only be deactivated when the elevator car is positioned in a predetermined maintenance position.

As shown in FIG. 6, in some embodiments, the second predetermined maintenance position may not be employed, and thus the flow process 600 may proceed from block 610 (opening landing doors) to block 616 (close landing doors). In such flow process, a maintenance operation or action may be performed by a mechanic between the two actions, and then the elevator system may be returned to normal operation mode and the landing door lock can be disabled to prevent operation/opening thereof.

Although described with respect to a specific order of events or steps, those of skill in the art will appreciate that some of the steps may be switched, the order may be different, additional steps or elements can be incorporated therein, and/or various steps of the flow process can be removed or not present in some embodiments. That is, the flow process 600 is intended to be non-limiting and is provided for illustrative and explanatory purposes. For example, although described with two predetermined maintenance positions, those of skill in the art will appreciate that any number of predetermined maintenance positions may be employed without departing from the scope of the present disclosure. Further, although described with respect to a specific landing within a building, those of skill in the art will appreciate that the flow process is not limited by a specific arrangement of components or parts.

Although described with respect to an elevator shaft having four landings, those of skill in the art will appreciate that any size (number of landings) elevator shaft can employ embodiments as described herein. Further, although described with only one landing having an access control module and a single, respective landing door lintel lock, those of skill in the art will appreciate that multiple landings can be similarly configured with a respective access control module and landing door lintel lock. Further, in some embodiments, a single access control module can be used to enable access to multiple different landings that have landing door lintel locks. For example, an access control module can be positioned at the ground floor of a 20 story building and landings 5, 10, 15, and 19 may have landing door lintel locks. In one non-limiting example, a building may have a number of floors N_{floors}. In such building, Floor N_{floors}−1 (i.e., second from top) can be configured with an access control module and a landing door lintel lock (i.e., the second to highest floor may have the access control module and landing door lintel lock). Having the access control module and landing door lintel lock on such a floor ensures adequate space or headroom for the elevator car to move upward into the second maintenance position. However, those of skill in the art will appreciate that the elevator maintenance access systems of the present disclosure can be positioned at any floor, including the lowest and/or highest floors in a building.

Further, although described herein with the intention to provide access to an elevator car lintel or elevator car sill, those of skill in the art will appreciate that the first and second maintenance positions (or any number of predetermined positions) can be used for various maintenance and/or emergency operations. Thus, the present disclosure is not limited to only two predetermined positions or even that a first maintenance position is for access to an elevator car lintel and a second maintenance position is for access to an elevator car sill. For example, in some embodiments, one predetermined position can be set to enable access to an elevator pit of the elevator shaft (e.g., at the lowest landing within an elevator shaft). Similarly, one predetermined position can be set to enable access to an elevator machine or component at the top of an elevator shaft (e.g., at the highest landing within an elevator shaft).

Advantageously, embodiments provided herein enable maintenance of elevator cars to be performed from a landing, and thus not requiring a mechanic to enter an elevator shaft of an elevator system. For example, one or more predetermined maintenance positions can be programmed or otherwise set within a maintenance mode of operation such that an elevator car can be automatically moved to a specific position relative to a landing to thus enable a mechanic to perform a maintenance action on a specific part of the elevator car. Further, advantageously, embodiments provided herein can incorporate a landing door lock access prevention device such that the access prevention device is only disengaged when the elevator car is in a predetermined maintenance position, and otherwise prevents access to the landing door lock.

As used herein, the use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. A method of operating an elevator system comprising:
receiving input regarding a maintenance action at an access control module, the input including a first predetermined maintenance position, the first predetermined maintenance position being a position of the elevator car within an elevator shaft relative to a landing;
conveying an elevator car to the first predetermined maintenance position;
disabling an access prevention device of a landing door lock; and
opening a landing door at the landing to enable access to the elevator car positioned at the first predetermined maintenance position.

2. The method of claim 1, further comprising entering a maintenance mode of operation prior to receiving input regarding the maintenance action.

3. The method of claim 1, wherein the first predetermined maintenance position is a position of the elevator car relative to the landing that enables access to a first part of the elevator car when the landing door is opened.

4. The method of claim 3, wherein the first part of the elevator car is an elevator car lintel.

5. The method of claim 3, wherein the first predetermined maintenance position is a position that defines a first gap between an elevator car lintel top and a landing door top.

6. The method of claim 5, wherein the first gap is about 300 mm (11.81 inches).

7. The method of claim 1, where the input further includes a second predetermined maintenance position, the second predetermined maintenance position being a position of the elevator car within the elevator shaft relative to the landing that is different from the first predetermined maintenance position.

8. The method of claim 7, wherein the second predetermined maintenance position is a position of the elevator car relative to the landing that enables access to a second part of the elevator car that is different from the first part when the landing door is opened.

9. The method of claim 8, wherein the second part of the elevator car is an elevator car sill.

10. The method of claim 8, wherein the second predetermined maintenance position is a position that defines a second gap between an elevator car sill bottom and a landing door bottom.

11. The method of claim 10, wherein the second gap is about 100 mm (3.94 inches).

12. The method of claim 1, further comprising moving the elevator car relative to the first predetermined maintenance position based on input received at the access control module.

13. The method of claim 12, wherein the movement of the elevator car relative to the first predetermined maintenance position is constrained to a predetermined maximum range.

14. The method of claim 1, further comprising:
closing the landing door; and
activating the access prevention device of the landing door lock.

15. The method of claim 1, wherein the landing is a landing within a building that is second from the highest landing within the elevator shaft.
